(19) United States
(12) Patent Application Publication
(10) Pub. No.: US 2003/0002539 A1
(43) Pub. Date: Jan. 2, 2003

(54) Method of and system for packet communication, and computer readable recording medium having program for making computer execute the method recorded thereon

(76) Inventors: Keiichi Soda, Tokyo (JP); Tatsuki Ichihashi, Tokyo (JP)

Correspondence Address: BIRCH STEWART KOLASCH & BIRCH, PO BOX 747, FALLS CHURCH, VA, 22040-0747, US

(21) Appl. No.: 10/019,646

(22) PCT Filed: Dec. 13, 2000
(86) PCT No.: PCT/JP00/08825

(30) Foreign Application Priority Data
Jun. 14, 2000 (JP) 2000-178940

(51) Int. Cl. H04J 3/06

(52) U.S. Cl. 370/509; 370/516

(57) ABSTRACT

Each of terminal equipments (11, 12) and multiplexing equipments (13) transmits a synchronization control packet to an adjacent terminal equipment or relay equipment in synchronism with an own synchronization timing signal. In the wake of the synchronization control packet, each of terminal equipments and multiplexing equipments transmits information packets having a length and a number predetermined for each terminal equipment, toward an opposite terminal equipment. Each of the terminal equipments (13) temporarily holds information packets received between the current synchronization timing signal and the next synchronization timing signal, and relays the held information packets in the wake of the synchronization control packet in synchronizm with the next synchronization timing signal.

### TECHNICAL FIELD

The present invention relates to a plurality of terminal equipments that operate according to mutually synchronized periodic timing signals, a packet communication system including at least one relay equipment, and its synchronizing technique. Especially this invention relates to a packet communication system capable of improving the band utilization factor of a transmission path and definitely assuring a maximum value of a transmission delay time required since a terminal equipment transmits an information packet until the information packet arrives at an opposite terminal equipment.

### BACKGROUND ART

FIG. 11 is a block diagram showing a configuration of a prior art packet communication system described in Japanese Patent Application Laid-Open No. 7-283804. Numeral 1 denotes a transmission side terminal equipment, numeral 2 denotes a reception side terminal equipment, numeral 3 denote A/D conversion circuits, numeral 4 denotes a packet assembly circuit, numeral 5 denotes a packet disassembly circuit, and numeral 6 denote D/A conversion circuits.

In this packet communication system, the A/D conversion circuits 3 are supplied with analog input signals ch1(i), . . . , chX(i) which are input signals for the transmission side terminal equipment 1. The analog input signals ch1(i), . . . , chX(i) are mutually synchronized in A/D conversion timing in the transmission side terminal equipment 1. The A/D conversion circuits 3 perform A/D conversion simultaneously on the supplied analog input signals ch1(i), . . . , chX(i) respectively at periods T, and output resultant digital signals to the packet assembly circuit 4.

The packet assembly circuit 4 provided in a stage subsequent to that of the A/D conversion circuits 3 transmits a synchronization control packet to the reception side terminal equipment 2 at periods T, and notifies the reception side terminal equipment 2 of A/D conversion timing of the A/D conversion circuits 3. Analog signal information (digital signal) obtained by A/D conversion conducted by the A/D conversion circuits 3 is stored in as many information packets as required. In the wake of the synchronization control packet, the information packets are transmitted to the receiving side terminal equipment 2. For example, if input channels of the analog input signals ch1(i), . . . , chX(i) are eight channels and two pieces of analog signal information (digital signal) are stored in one information packet, then four information packets are transmitted to the reception side terminal equipment 2.

Upon receiving a synchronization control packet, the packet disassembly circuit 5 reproduces the A/D conversion timing of the transmission side terminal equipment 1. Furthermore, upon receiving information packets from the packet assembly circuit 4, the packet disassembly circuit 5 takes out analog signal information (digital signal) included in the information packets, and delivers the analog signal information (digital signal) to a pertinent D/A conversion circuit 6.

The D/A conversion circuits 6 provided in a stage subsequent to the packet disassembly circuit 5 perform D/A conversion on respective analog signal information pieces (digital signals) in synchronism with an A/D conversion timing signal reproduced by the packet disassembly circuit 5, and output analog output signals ch1(o), . . . , chX(o) from analog signal output channels provided for the D/A conversion circuits 6 in one-to-one correspondence. Owing to the operation heretofore described, a plurality of analog signals are transmitted from the transmission side terminal equipment 1 to the reception side terminal equipment 2 synchronously.

When the prior art packet communication system is applied to a large scale packet communication system comprised of a plurality of transmission side terminal equipments 1, at least one reception side terminal equipment 2, and at least one relay equipment (such as an exchange equipment having an exchange function of N:N and a multiplexing equipment having a multiplexing and broadcast function of 1:N), there are the following problems.

To begin with, a first problem is that the transmission side terminal equipment 1 transmits the synchronization control packet to the reception side terminal equipment one-sidedly and consequently it is difficult to achieve timing synchronization between a plurality of transmission side terminal equipments 1 and at least one reception side terminal equipment.

Furthermore, a second problem is that in the case where packets directed to the same route and received by a relay equipment are subject to multi-relay in the order of arrival, multiplexing and demultiplexing are repeated every passage through a relay equipment, and arrival intervals of information packets fluctuates at each of the relay equipment and the reception side terminal equipment 2. There is also a problem that a packet reception buffer having a large capacity becomes necessary in each of the relay equipments and the reception side terminal equipment 2 in order to cope with the fluctuation.

And a third problem is that because of the above-mentioned fluctuation it is difficult to fix a maximum value of transmission delay time required since the transmission terminal equipment 1 transmits information packets until the reception terminal equipment 2 receives the information packets.

There is a problem that especially the second and third problems become further remarkable in the case where the transmission side terminal equipment 1 has transmitted nonpreferential packets of best effort type and information packets mixedly, or in the case where the packet length is made not fixed but variable.

Therefore, an object of the present invention is to provide a packet communication system, a packet communication method, and a computer readable recording medium having a computer program for making a computer execute the method recorded thereon capable of reducing the capacity of the packet reception buffer and definitely assuring a maximum value of a transmission delay time of information packets.

### DISCLOSURE OF THE INVENTION

A packet communication system according to the present invention is a packet communication system comprises: a plurality of terminal equipments that conduct communication operation at periodic timing; and relay equipments that relay packets given and received between said terminal equipments, wherein synchronization control packets for timing synchronization are transmitted between adjacent equipments to thereby establish synchronization of operation timing, each of said terminal equipments and relay equipments including a synchronization request unit which transmits a synchronization request packet to an adjacent equipment at own operation timing and thereby performs a synchronization request; a synchronization response unit which is responsive to acceptance of a synchronization request packet from said adjacent equipment, for transmitting a synchronization response packet corresponding to the synchronization request packet according to own synchronization timing and thereby conducting a synchronization response; a calculation unit which calculates a synchronization deviation value with respect to an adjacent equipment on the basis of a time difference between an arrival time of the synchronization response packet transmitted from said adjacent equipment and own operation timing; and a correction unit which corrects operation timing of the own equipment on the basis of the synchronization deviation value calculated by said calculation unit.

According to this invention, each of the terminal equipments and relay equipments transmits a synchronization request packet to an adjacent equipment at its own operation timing and thereby conducts a synchronization request. When a synchronization request packet is accepted from the adjacent equipment, each of the terminal equipments and relay equipments transmits a synchronization response packet corresponding to the synchronization request packet according to its own synchronization timing and thereby conducts a synchronization response, calculates a synchronization deviation value with respect to an adjacent equipment on the basis of a time difference between an arrival time of the synchronization response packet transmitted from the adjacent equipment and own operation timing, and corrects the operation timing of the own equipment on the basis of the calculated synchronization deviation value. As a result, timing synchronization can be executed among a plurality of terminal equipments. The capacity of the packet reception buffer can be reduced. The maximum value of the transmission delay time of the information packets can be definitely assured.

A packet communication system according to the next invention is wherein each of said terminal equipments comprises an information packet transmission unit which transmits information packets having a number and a length predetermined for each terminal equipment toward an opposite terminal equipment in the wake of the synchronization request, and each of said relay equipments comprises a storage unit which temporarily stores information packets received between the current operation timing and next operation timing; and a relay unit which relays information packets stored in said storage unit in the wake of the synchronization request packet at next operation timing.

According to this invention, each of the terminal equipments transmits information packets having a number and a length predetermined for each terminal equipment toward an opposite terminal equipment in the wake of the synchronization request, and each of the relay equipments temporarily stores information packets received between the current operation timing and the next operation timing, and relays information packets temporarily stored in the storage unit in the wake of the synchronization request packet at next operation timing. As a result, packet communication can be conducted efficiently.

A packet communication system according to the next invention is wherein each of said relay equipments further comprises an extraction unit which extracts only data portions of information packets received between current operation timing and next operation timing, when relaying information packets from an N side route of a 1:N multiplexing and broadcasting communication system to a 1 side route; and a packet generation unit which generates packets having data portions extracted by said extraction unit and arranged in a predetermined order, and said relay unit relays packets generated by said packet generation unit in the wake of the synchronization request packet at next operation timing.

According to this invention, each of the relay equipments extracts only data portions of information packets received between current operation timing and next operation timing, when relaying information packets from an N side route of a 1:N multiplexing and broadcasting communication system to a 1 side route, generates packets having data portions extracted by the extraction unit and arranged in a predetermined order, and relays the packets in the wake of the synchronization request packet at next operation timing. Although the amount of processing of the relay equipment is increased, therefore, the multiplexing efficiency is improved. As a result, it becomes possible to cope with a large scale system.

A packet communication system according to the next invention is wherein said terminal equipments and relay equipments share a synchronization timing number that increases by 1 every operation timing according to timing synchronization control, and each of said relay equipments transmits packets having a number and a length predetermined for each terminal equipment toward an opposite terminal equipment in the wake of the synchronization request at operation timing specified by a synchronization timing number predetermined for each terminal equipment.

According to this invention, terminal equipments and relay equipments share a synchronization timing number that increases by 1 every operation timing according to timing synchronization control, and each of the relay equipments transmits packets having a number and a length predetermined for each terminal equipment toward an opposite terminal equipment in the wake of the synchronization request at operation timing specified by a synchronization timing number predetermined for each terminal equipment. Information packets are thus transmitted dispersedly. As compared with the case where the information packets are transmitted simultaneously, therefore, the multiplexing efficiency can be improved. As a result, it is possible to cope with a large scale system.

A packet communication system according to the next invention is wherein each of said terminal equipments and relay equipments transmits an equipment management packet for notification and collection of failure information and update of initial setting parameters and operation programs of respective equipments, toward an adjacent equipment in the wake of the synchronization request packet according to a length and a number predetermined for each of said terminal equipments and relay equipment.

According to this invention, each of the terminal equipments and relay equipments transmits an equipment management packet for notification and collection of failure information and update of initial setting parameters and operation programs of respective equipments, toward an adjacent equipment in the wake of the synchronization request packet according to a length and a number predetermined for each of the terminal equipments and relay equipment. Therefore, each equipment can transmit and receive the equipment management packet together with the synchronization control packet and the information packets. As a result, it is possible to constitute a system having a higher reliability.

A packet communication system according to the next invention is wherein each of said terminal equipments has packets of best effort type that are retransmitted by a communication procedure of a higher order layer even if said packets have been discarded because of system congestion, as nonpreferential information packets; when there is a time for transmitting information packets of a maximum length in an interval between transmission of an information packet and next operation timing, each of said terminal equipments transmits said nonpreferential information packets; and when there is a time required for transmission of information packets of a maximum length in an interval between relay and next operation timing, each of said relay equipments relays said nonpreferential information packets.

According to this invention, each of the terminal equipments has packets of best effort type that are retransmitted by a communication procedure of a higher order layer even if the packets have been discarded because of system congestion, as nonpreferential information packets. When there is a time for transmitting information packets of a maximum length in an interval between transmission of an information packet and next operation timing, each of the terminal equipments transmits the nonpreferential information packets toward opposite terminal equipment. When there is a time required for transmission of information packets of a maximum length in an interval between relay and next operation timing, each of the relay equipments relays the nonpreferential information packets. Therefore, each equipment can transmit and receive nonpreferential information packets together with the synchronization control packet and the information packets. By using the nonpreferential information packets, packet communication having a higher degree of freedom can be conducted.

A packet communication system according to the next invention is wherein each of said relay equipments further comprises a detection unit which detects an error of a timing synchronization procedure or an excess of the number of information packets between said relay equipment and an adjacent equipment; and a relay stoping unit which is responsive to detection of an error of a timing synchronization procedure or an excess of the number of information packets conducted by said detection unit, for stopping the relay of information packets until said error of a timing synchronization procedure or excess of the number of information packets is canceled.

According to this invention, each of the relay equipments detects an error of a timing synchronization procedure or an excess of the number of information packets between the relay equipment and an adjacent equipment. When an error of a timing synchronization procedure or an excess of the number of information packets has been detected, the relay equipment stops the relay of information packets until the error of a timing synchronization procedure or excess of the number of information packets is canceled. Therefore, information packets received from a fault equipment and disturbed in transmission period are not relayed, and consequently information packets received from other equipments can be relayed without obstructing them.

A packet communication method according to the next invention is a packet communication method that is applicable to a packet communication system, said packet communication system including a plurality of terminal equipments that conduct communication operation at periodic timing; and relay equipments that relay packets given and received between said terminal equipments, wherein synchronization control packets for timing synchronization are transmitted between adjacent equipments to thereby establish synchronization of operation timing. The packet communication method comprises: a synchronization request step at which each of said terminal equipments and relay equipments transmits a synchronization request packet to an adjacent equipment at own operation timing and thereby conducting a synchronization request; a synchronization response step at which, in response to acceptance of a synchronization request packet from said adjacent equipment, each of said terminal equipments and relay equipments transmits a synchronization response packet corresponding to the synchronization request packet according to own synchronization timing and thereby conducts a synchronization response; a calculation step at which each of said terminal equipments and relay equipments calculates a synchronization deviation value with respect to an adjacent equipment on the basis of a time difference between an arrival time of the synchronization response packet transmitted from said adjacent equipment and own operation timing; and a correction step at which each of said terminal equipments and relay equipments corrects operation timing of the own equipment on the basis of the synchronization deviation value calculated at the calculation step.

According to this invention, each of the terminal equipments and relay equipments transmits a synchronization request packet to an adjacent equipment at its own operation timing and thereby conducts a synchronization request. When a synchronization request packet is accepted from the adjacent equipment, each of the terminal equipments and relay equipments transmits a synchronization response packet corresponding to the synchronization request packet according to its own synchronization timing and thereby conducts a synchronization response, calculates a synchronization deviation value with respect to an adjacent equipment on the basis of a time difference between an arrival time of the synchronization response packet transmitted from the adjacent equipment and own operation timing, and corrects the operation timing of the own equipment on the basis of the calculated synchronization deviation value. As a result, timing synchronization can be executed among a plurality of terminal equipments. The capacity of the packet reception buffer can be reduced. The maximum value of the transmission delay time of the information packets can be definitely assured.

A packet communication method according to the next invention wherein in the above-mentioned invention the packet communication method further comprises: an information packet transmission step at which each of said terminal equipments transmits information packets having a number and a length predetermined for each terminal equipment toward an opposite terminal equipment in the wake of the synchronization request; and a relay step at which each of said relay equipments temporarily stores information packets received between the current operation timing and next operation timing, and relays information packets temporarily stored in said storage unit in the wake of the synchronization request packet at next operation timing.

According to this invention, each of the terminal equipments transmits information packets having a number and a length predetermined for each terminal equipment toward an opposite terminal equipment in the wake of the synchronization request packet, and each of the relay equipments temporarily stores information packets received between the current operation timing and the next operation timing, and relays the temporarily stored information packets in the wake of the synchronization request packet at next operation timing. As a result, packet communication can be conducted efficiently.

A packet communication method according to the next invention wherein in the above-mentioned invention the packet communication method further comprises an extraction step at which each of said relay equipments extracts only data portions of information packets received between current operation timing and next operation timing, when relaying information packets from an N side route of a 1:N multiplexing and broadcasting communication system to a 1 side route; and a packet generation step at which each of said relay equipments generate packets having data portions extracted at said extraction step and arranged in a predetermined order, and at the relay step, packets generated at the packet generation step are relayed in the wake of the synchronization request packet at next operation timing.

According to this invention, each of the relay equipments extracts only data portions of information packets received between current operation timing and next operation timing, when relaying information packets from an N side route of a 1:N multiplexing and broadcasting communication system to a 1 side route, generates packets having data portions extracted at the extraction step and arranged in a predetermined order, and relays the packets in the wake of the synchronization request packet at next operation timing. Although the amount of processing of the relay equipment is increased, therefore, the multiplexing efficiency is improved. As a result, it becomes possible to cope with a large scale system.

A packet communication method according to the next invention wherein said terminal equipments and relay equipments share a synchronization timing number that increases by 1 every operation timing according to timing synchronization control, and each of said relay equipments transmits packets having a number and a length predetermined for each terminal equipment toward an opposite terminal equipment in the wake of the synchronization request at operation timing specified by a synchronization timing number predetermined for each terminal equipment.

According to this invention, terminal equipments and relay equipments share a synchronization timing number that increases by 1 every operation timing according to timing synchronization control, and each of the relay equipments transmits packets having a number and a length predetermined for each terminal equipment toward an opposite terminal equipment in the wake of the synchronization request at operation timing specified by a synchronization timing number predetermined for each terminal equipment. Information packets are thus transmitted dispersedly. As compared with the case where the information packets are transmitted simultaneously, therefore, the multiplexing efficiency can be improved. As a result, it is possible to cope with a large scale system.

A packet communication method according to the next invention wherein each of said terminal equipments and relay equipments transmits an equipment management packet for notification and collection of failure information and update of initial setting parameters and operation programs of respective equipments, toward an adjacent equipment in the wake of the synchronization request packet according to a length and a number predetermined for each of said terminal equipments and relay equipment.

According to this invention, each of the terminal equipments and relay equipments transmits an equipment management packet for notification and collection of failure information and update of initial setting parameters and operation programs of respective equipments, toward an adjacent equipment in the wake of the synchronization request packet according to a length and a number predetermined for each of the terminal equipments and relay equipment. Therefore, each equipment can transmit and receive the equipment management packet together with the synchronization control packet and the information packets. As a result, it is possible to constitute a system having a higher reliability.

A packet communication method according to the next invention wherein each of said terminal equipments has packets of best effort type that are retransmitted by a communication procedure of a higher order layer even if said packets have been discarded because of system congestion, as nonpreferential information packets; when there is a time for transmitting information packets of a maximum length in an interval between transmission of an information packet and next operation timing, each of said terminal equipments transmits said nonpreferential information packets toward opposite terminal equipment; and when there is a time required for transmission of information packets of a maximum length in an interval between relay and next operation timing, each of said relay equipments relays said nonpreferential information packets.

According to this invention, each of the terminal equipments has packets of best effort type that are retransmitted by a communication procedure of a higher order layer even if the packets have been discarded because of system congestion, as nonpreferential information packets. When there is a time for transmitting information packets of a maximum length in an interval between transmission of an information packet and next operation timing, each of the terminal equipments transmits the nonpreferential information packets toward opposite terminal equipment. When there is a time required for transmission of information packets of a maximum length in an interval between relay and next operation timing, each of the relay equipments relays the nonpreferential information packets. Therefore, each equipment can transmit and receive nonpreferential information packets together with the synchronization control packet and the information packets. By using the nonpreferential information packets, packet communication having a higher degree of freedom can be conducted.

A packet communication method according to the next invention wherein the above-mentioned invention the packet communication method further comprises: a detection step at which each of said relay equipments detects an error of a timing synchronization procedure or an excess of the number of information packets between said relay equipment and an adjacent equipment; and a relay stop step at which, in response to detection of an error of a timing synchronization procedure or an excess of the number of information packets at said detection step, each of said relay equipments stops the relay of information packets until said error of a timing synchronization procedure or excess of the number of information packets is canceled.

According to this invention, each of the relay equipments detects an error of a timing synchronization procedure or an excess of the number of information packets between the relay equipment and an adjacent equipment. When an error of a timing synchronization procedure or an excess of the number of information packets has been detected, the relay equipment stops the relay of information packets until the error of a timing synchronization procedure or excess of the number of information packets is canceled. Therefore, information packets received from a fault equipment and disturbed in transmission period are not relayed, and consequently information packets received from other equipments can be relayed without obstructing them.

On a recording medium according to the next invention, a computer program for making a computer execute the above-mentioned method is recorded. Accordingly, it becomes possible to read the computer program by using a machine. As a result, it is possible to implement any one of operation of the above-mentioned method by using a computer.

### BRIEF DESCRIPTION OF THE DRAWINGS

FIG. 1 is a diagram showing a configuration of a packet communication system according to a first embodiment of the present invention;

FIG. 2 is a diagram showing a timing synchronization procedure between a master and a submaster that are adjacent to each other;

FIG. 3 is a diagram showing internal configurations of a transmission side terminal equipment, a multiplexing equipment, and a reception side terminal equipment;

FIG. 4 is a diagram showing another configuration of a packet communication system of the first embodiment;

FIG. 5 is a timing chart showing operations of respective equipments in the first embodiment having the system configuration shown in FIG. 4;

FIG. 6 is a timing chart showing operations of respective equipments in a second embodiment having the system configuration shown in FIG. 4;

FIG. 7 is a timing chart showing operations of respective equipments in a third embodiment having the system configuration shown in FIG. 4;

FIG. 8 is a timing chart showing operations of respective equipments in a fourth embodiment having the system configuration shown in FIG. 4;

FIG. 9 is a timing chart showing operations of respective equipments in a fifth embodiment having the system configuration shown in FIG. 4;

FIG. 10 is a diagram showing operation of a multiplexing equipment in the case where a failure of an adjacent equipment is detected in a packet communication system of the fifth embodiment; and

FIG. 11 is a diagram showing a configuration of a conventional packet communication system.

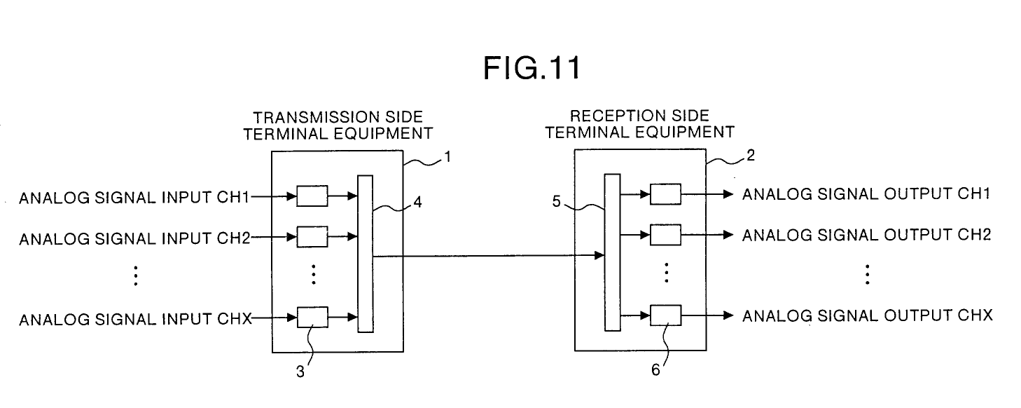

### BEST MODE FOR CARRYING OUT THE INVENTION

Embodiments of a packet communication system, a synchronization control method, and a computer readable recording medium having a computer program for making a computer execute the method recorded thereon according to the present invention will be described in detail by referring to the accompanying drawing.

First Embodiment

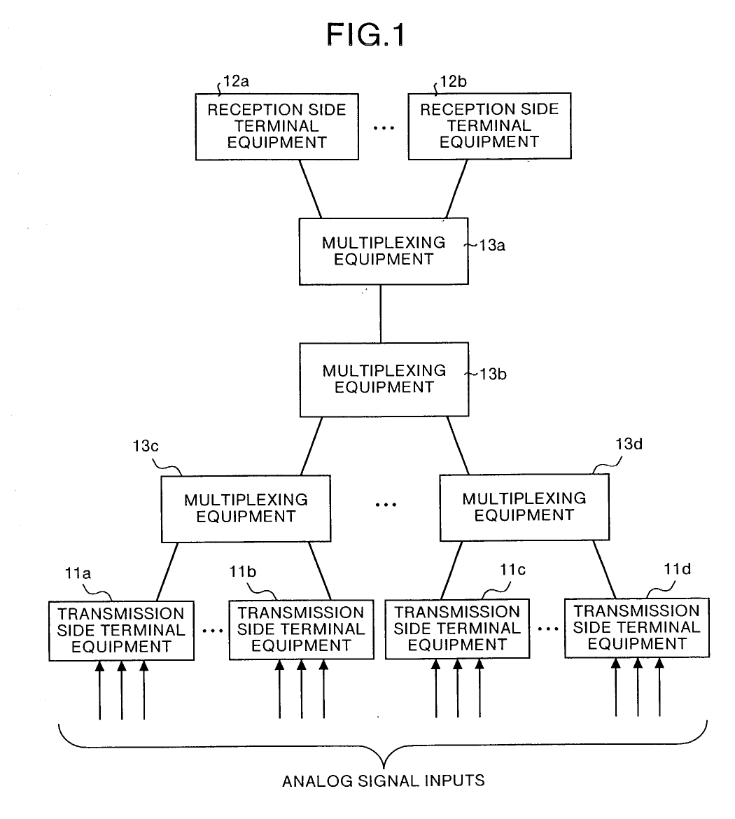

To begin with, a system configuration of a packet communication system according to the present first embodiment will be described. FIG. 1 is a diagram showing a system configuration of a packet communication system according to the present first embodiment. In FIG. 1, 11a, 11b, 11c and 11d denote transmission side terminal equipments, 12a and 12b denote reception side terminal equipments, and 13a, 13b, 13c and 13d denote multiplexing equipments.

This packet communication system includes a plurality of transmission side terminal equipments 11a to 11d (hereafter referred generically to as “transmission side terminal equipments 11”) and a plurality of reception side terminal equipments 12a to 12d (hereafter referred generically to as “reception side terminal equipments 12”), which execute communication operation in synchronism with a periodic timing signal, and at least one multiplexing equipments 13a to 13d (hereafter referred generically to as “multiplexing equipments 13”), which relay packets transmitted and received between the transmission side terminal equipments 11 and reception side terminal equipments 11.

By the way, in such a packet communication system, timing of all equipments included in the system is synchronized by making a synchronization control packet for timing synchronization go back and forth between a terminal equipment and a relay equipment that are adjacent to each other or between relay equipments. By the way, analog signals are input to the transmission side terminal equipments 11.

The multiplexing equipment 13c conducts multiplexing processing of superposing signals of multiple channels supplied from the transmission side terminal equipments 11a to 11b, combining them into one channel, and generating information packets. The multiplexing equipment 13d conducts multiplexing processing of superposing signals of multiple channels supplied from the transmission side terminal equipments 11c to 11d, and combining them into one channel.

The multiplexing equipment 13b receives information packets from the multiplexing equipment 13c and the multiplexing equipment 13d, and relays them to the reception side multiplexing equipment 13a. The multiplexing equipment 13a transmits the information packets relayed from the multiplexing equipment 13b to the reception side terminal equipments 12a to 12b.

In the packet communication system of the present embodiment, respective equipments are defined with respect to the synchronization control as follows, in order to conduct timing synchronization among all terminal equipments. Furthermore, also in the case where a loop path is formed in the system, similar defining is conducted by virtually cutting the loop path apart and regarding the loop path as a radial path centering around a master.

In other words, one of all equipments is determined to be a master. “Master” means a synchronization timing source of a period T in all equipments. By the way, in the present embodiment, the packet communication system is designed so that the sum of the total transmission time of information packets transmitted by all transmission terminal equipments 11 during a period T and transmission time of one packet of the synchronization control packet will not exceed the period T.

Furthermore, multiplexing equipments other than the master are determined to be submasters. Each of the submasters is slave-synchronized with an adjacent master or submaster. Between submasters, a submaster located far away from the master is slave-synchronized with a submaster located near the master.

For example, if the multiplexing equipment 13b (relay equipment) has been determined to be a master, then the multiplexing equipments 13a, 13c and 13d (relay equipments) other than the multiplexing equipment 13b (master) become submasters.

In addition, the transmission side terminal equipments 11 and the reception side terminal equipments 12 other than the master are made to be slaves. Each of the transmission side terminal equipments 11 and the reception side terminal equipments 12 (slaves) slave-synchronizes with an adjacent master or submaster.

For example, if the multiplexing equipment 13b (relay equipment) has been determined to be a master, then the transmission side terminal equipments 11a, 11b, 11c and 11d and the reception side terminal equipments 12a and 12b become slaves. The transmission side terminal equipments 11a to 11b (slaves) are slave-synchronized with the adjacent multiplexing equipment 13c (submaster). The transmission side terminal equipments 11c to 11d (slaves) are slave-synchronized with the adjacent multiplexing equipment 13d (submaster). The reception side terminal equipments 12a to 12b (slaves) are slave-synchronized with the adjacent multiplexing equipment 13a (submaster).

In the packet communication system of the present embodiment, timing synchronization is achieved by making a synchronization control packet go back and forth between adjacent equipments on the basis of the definition heretofore described. As combinations of adjacent equipments, there can be considered four ways: the master and a submaster, a submaster and a slave, the master and a slave, and a submaster near the master and a submaster far away from the master.

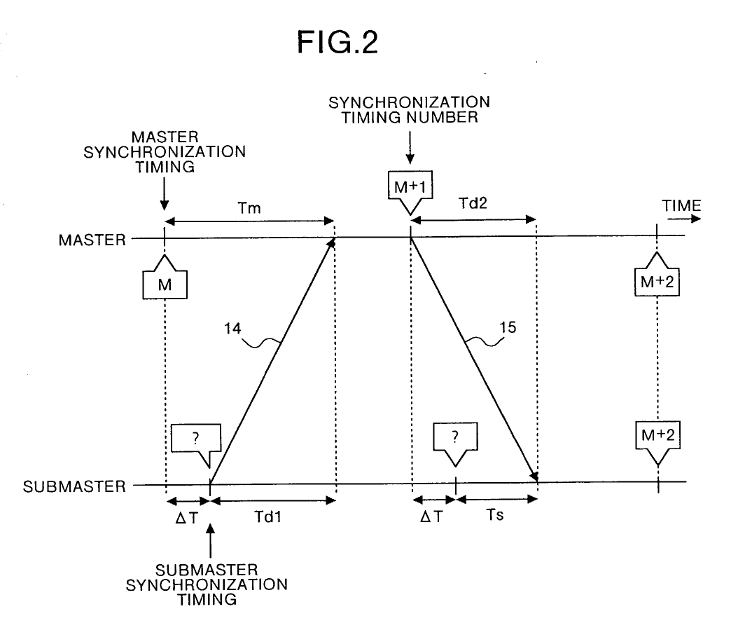

FIG. 2 is a diagram showing a timing synchronization procedure between the master and a submaster that are adjacent to each other. In FIG. 2, numeral 14 denotes a synchronization control packet at the time of request, and numeral 15 denotes a synchronization control packet at the time of response.

With reference to FIG. 2, timing synchronization between the master and a submaster that are adjacent to each other will be described hereafter. Since timing synchronization is conducted in the same way for other combinations other than the master and a submaster as well, description thereof will be omitted here.

In the packet communication system of the present embodiment, first the submaster transmits a synchronization control packet 14 (request) to the master at a period longer than the period T in synchronism with a synchronization timing signal of the submaster itself (first timing synchronization procedure).

Subsequently, upon receiving the synchronization control packet 14 (request) in the first timing synchronization procedure, the master measures a time difference Tm in arrival time between an immediately preceding synchronization timing signal of itself and the pertinent synchronization timing signal (second timing synchronization procedure).

Subsequently, the master stores a time difference Tm in the second timing synchronization procedure and a synchronization timing number (illustrated M+1) at the time when the packet has been transmitted, in the synchronization control packet 15 (response), and transmits the synchronization control packet 15 (response) to the submaster in synchronism with a synchronization timing signal of itself (third timing synchronization procedure).

Subsequently, upon receiving the synchronization control packet 15 (response) in the third timing synchronization procedure, the submaster measures a time difference Ts in arrival time between an immediately preceding synchronization timing signal of itself and the pertinent synchronization timing signal (fourth timing synchronization procedure).

Denoting a transmission delay time of an outward trip transmission path by Td1, a transmission delay time of a return trip transmission path by Td2, and a deviation in synchronization timing between the master and the submaster by ΔT, relations Tm=ΔT+Td1 and Td2=ΔT+Ts are satisfied as shown in FIG. 2.

And the transmission delay time Td1 of the outward trip transmission path is equal to the transmission delay time Td2 of the return trip transmission path. In other words, the outward trip and return trip transmission delay times of the transmission path are equal (Td1=Td2) Therefore, the following equation:

ΔT=(Tm−Ts)/2 (1)

is satisfied.

Accordingly, the submaster calculates ΔT by using the equation (1), and makes the synchronization timing of itself coincide with the synchronization timing signal of the master (fifth timing synchronization procedure). On the basis of the synchronization timing number (illustrated M+1) stored in the synchronization control packet 15 (response) in the third timing synchronization procedure, the submaster makes the synchronization timing number of itself coincide with a synchronization timing number (illustrated M) of the master (sixth timing synchronization procedure).

In the packet communication system of the present embodiment, timing synchronization is achieved between adjacent equipments one after another by executing the first timing synchronization procedure to the sixth timing synchronization procedure described heretofore. Timing synchronization of all equipments ranging from the master to the terminal slaves are thus achieved by taking the master as a synchronization timing source.

By the way, the equation (1) is satisfied only when the outward trip and return trip transmission delay times of the transmission path are equal. Therefore, each equipment needs to transmit a synchronization control packet with a fixed delay from synchronization timing of itself without fluctuation. Internal configurations of the packet communication system of the present embodiment and its operation required therefor will be described hereafter.

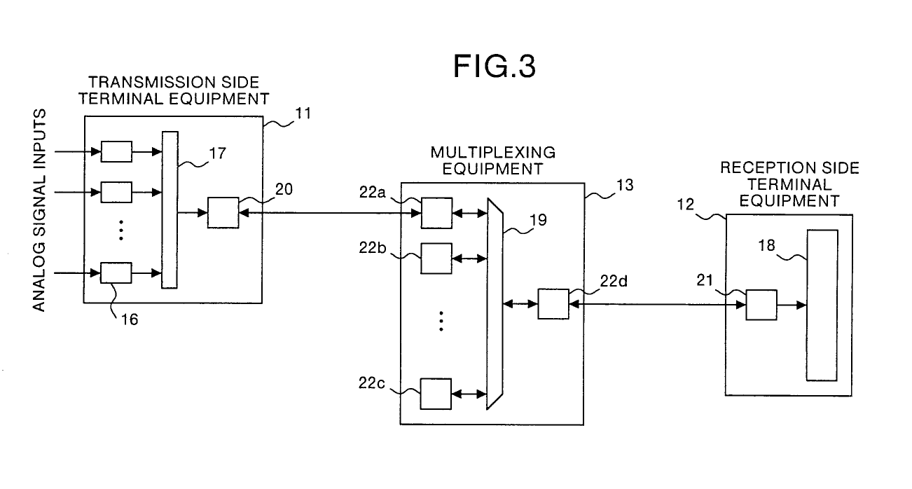

Internal configurations of the transmission side terminal equipment 11, the multiplexing equipment 13, and the reception side terminal equipment 12 are shown in FIG. 3. In FIG. 3, numeral 11 denotes a transmission side terminal equipment, numeral 12 denotes a reception side terminal equipment, numeral 13 denotes a multiplexing equipment, numeral 16 denotes an A/D conversion circuit, numeral 17 denotes a packet assembly circuit, numeral 18 denotes a packet processing circuit, numeral 19 denotes a packet multiplexing and broadcasting circuit, and numerals 20, 21, 22a, 22b, . . . , 22c and 22d denote synchronization control circuits.

In the packet communication system of the present embodiment, other synchronization control circuits in the multiplexing equipment 13 are first synchronized with a synchronization timing signal of one of the synchronization control circuits 22a, 22b, . . . , 22c and 22d. For example, if the multiplexing equipment 13 is the master and the synchronization control circuit 22d is the synchronization timing source, then the synchronization control circuits 22a, 22b, . . . , 22c are synchronized with the synchronization control circuit 22d. Furthermore, if the multiplexing equipment 13 is a submaster and a master is connected beyond the synchronization control circuit 22d, then the synchronization control circuits 22a, 22b, . . . , 22c are synchronized with the synchronization control circuit 22d.

Subsequently, in the transmission side terminal equipment 11, information packets are transmitted as heretofore described. First, the synchronization control circuit 20 transmits a synchronization control packet to an adjacent equipment in synchronism with a synchronization timing signal in accordance with the above-mentioned timing synchronization procedure, and conducts timing synchronization (first transmission step).

Subsequently, the A/D conversion circuit 16 conducts A/D conversion on an input analog signal in synchronism with a synchronization timing signal (second transmission step). Thereafter, the packet assembly circuit 17 stores analog signal information (digital signal) after the A/D conversion in data areas of information packets (third transmission step).

Subsequently, in the case where a synchronization control packet is transmitted toward an adjacent equipment in synchronism with a synchronization timing signal, the packet assembly circuit 17 transmits the information packets generated at the third transmission step toward the opposite reception side terminal equipment 12 in the wake of the synchronization control packet in the period T, according to a packet length and the number of packets determined previously for each transmission side terminal equipment 11. Furthermore, in the case where a synchronization control packet is not transmitted, the packet assembly circuit 17 transmits the information packets toward the opposite reception side terminal equipment 12 in synchronism with a synchronization timing signal (fourth transmission step).

Subsequently, in the multiplexing equipment 13, information packets received from an N side route of a 1:N multiplexing and broadcasting communication system are relayed to a 1 side route of the 1:N multiplexing and broadcasting communication system as described hereafter. That is, each of the synchronization control circuits 22a, 22b, . . . , 22c and 22d transmits a synchronization control packet to an adjacent equipment in synchronism with a synchronization timing signal in accordance with the above-mentioned timing synchronization procedure, and thereby conducts timing synchronization (first relay step).

Subsequently, the packet multiplexing and broadcasting circuit 19 temporarily holds a plurality of information packets received in a period T, by using the synchronization timing of its own equipment as a reference (second relay step).

Subsequently, in the case where a synchronization control packet is transmitted toward an adjacent equipment in synchronism with a synchronization timing signal, the packet multiplexing and broadcasting circuit 19 transmits a plurality of information packets generated at the second relay step one after another in the wake of the synchronization control packet. In the case where a synchronization control packet is not transmitted, the packet multiplexing and broadcasting circuit 19 transmits a plurality of information packets generated at the second relay step one after another in synchronism with a synchronization timing signal (third relay step). Furthermore, the multiplexing equipment 13 conducts broadcast relay of information packets as well received from an 1 side route of a 1:N multiplexing and broadcasting communication system to an N side route of the 1:N multiplexing and broadcasting communication system in the same way as the foregoing description (fourth relay step).

Subsequently, the reception side terminal equipment 12 processes information packets as heretofore described. That is, the synchronization control circuit 21 transmits a synchronization control packet to an adjacent equipment in synchronism with a synchronization timing signal in accordance with the above-mentioned timing synchronization procedure, and there by conducts timing synchronization. On the other hand, the packet processing circuit 18 takes out analog signal information (digital signal) from received information packets, and conducts predetermined processing in synchronism with the above-mentioned synchronization timing signal.

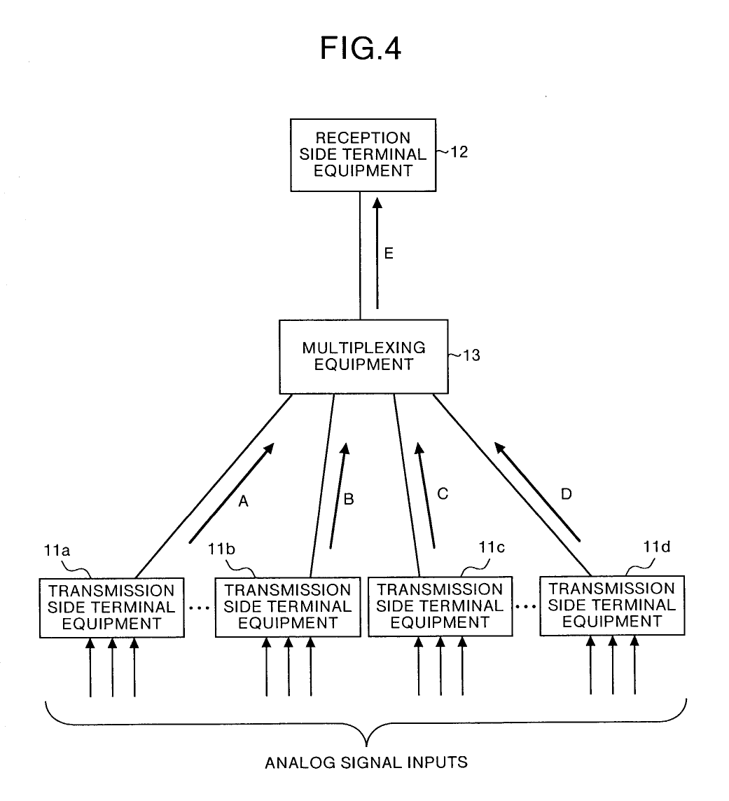

FIG. 4 is a function block diagram showing the remaining configuration of the packet communication system of the first embodiment. In FIG. 4, 11a, 11b, 11c and 11d denote transmission side terminal equipments, numeral 12 denotes a reception side terminal equipment, and numeral 13 denotes a multiplexing equipment.

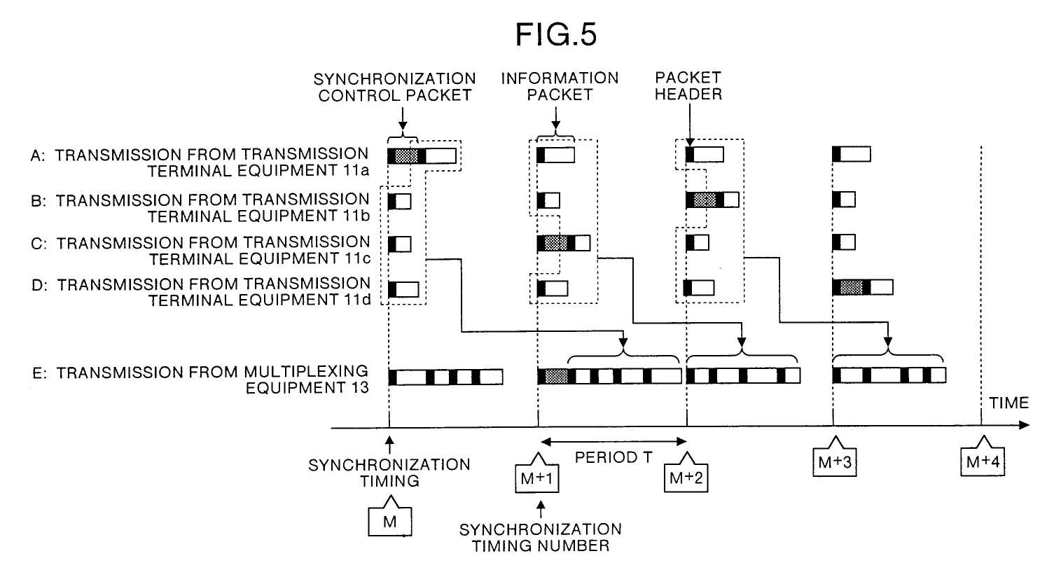

Operation (synchronizing method) of the equipments in the first embodiment having the system configuration shown in FIG. 4 will now be described by referring to a timing chart of FIG. 5. Timing charts A, B, C, D and E in FIG. 5 correspond to transmission of directions of arrows A, B, C, D and E in FIG. 4.

Defining the multiplexing equipment 13 as the master and defining the reception side terminal equipment 12 and the transmission side terminal equipments 11a, 11b, 11c and 11d as slaves, FIG. 4 shows how packets are transferred from the transmission side terminal equipments 11a, 11b, 11c and 11d to the reception side terminal equipment 12. Furthermore, a state after timing synchronization has been achieved in all equipments is shown. Each of the transmission side terminal equipments 11a, 11b, 11c and 11d transmits one information packet in each period T.

As shown in FIG. 5, in the packet communication system of the present embodiment, the transmission operation of the synchronization control packet and the transmission operation of information packets do not compete with each other in the transmission side terminal equipments 11a, 11b, 11c and 11d and the multiplexing equipment 13. Each of the transmission side terminal equipments 11a, 11b, 11c and 11d and the multiplexing equipment 13 can transmit the synchronization control packet with a delay of a fixed delay time from its own synchronization timing. Furthermore, the amount of storage of information packets in the multiplexing equipment 13 and the reception side terminal equipment 12 does not exceed the number of information packets received during the period T. The required capacity of the packet reception buffer is a capacity required to store packets corresponding to the transmission time equal to the period T.

If information packets arrive at the multiplexing equipment 13 in the packet communication system of the present embodiment, then the information packets are transmitted necessarily within the next period T as shown in FIG. 5. A maximum value of the transmission delay time required since the transmission side terminal equipments 11a, 11b, 11c and 11d transmit information packets until the reception side terminal equipment 12 can be defined by the following equation (2).

Maximum value of transmission delay time of information packets=period T×(the number of multiplexing equipments passed through +1) (2)

According to the packet communication system of the first embodiment of the present invention, respective equipments operate as heretofore described. Even in the case where a large scale packet communication system is constituted, the following effects are obtained. First, a first effect is that timing synchronization can be achieved among a plurality of terminal equipments. A second effect is that the capacity of the packet reception buffer can be made small. A third effect is that the maximum value of the transmission delay time of information packets can be definitely assured.

Second Embodiment

A second embodiment of the present invention will be described in detail by referring to the drawing. An object of a packet communication system according to a second embodiment is to improve the multiplexing efficiency in comparison with the first embodiment.

A configuration of the system is similar to that of the first embodiment shown in FIG. 1. Configurations of respective equipments, operation relating to timing synchronization, and transmission operation of information packets of the transmission side terminal equipments 11 (11a, 11b, 11c and 11d) are similar to those of the first embodiment. However, only the information packet relay operation of the multiplexing equipments 13 (multiplexing equipments 13a, . . . , 13d) differs from that of the first embodiment. Hereafter, therefore, only portions different from the first embodiment will be described. The same portions as those already described with reference to the first embodiment are denoted by like characters, and duplicated description will be omitted.

As shown in FIG. 3, a multiplexing equipment 13 of the present embodiment, information packets received from an N side route of a 1:N multiplexing and broadcasting communication system are relayed to a 1 side route of the 1:N multiplexing and broadcasting communication system as described hereafter. First, each of the synchronization control circuits 22a, 22b, . . . , 22c and 22d transmits a synchronization control packet to an adjacent equipment in synchronism with a synchronization timing signal in accordance with the above-mentioned timing synchronization procedure, and thereby conducts timing synchronization (first relay step).

Subsequently, the packet multiplexing and broadcasting circuit 19 extracts only data areas except packet header included in a plurality of information packets received within a period T, rearranges the data areas in a predetermined order, and compiles them into one packet. If at this time a limit of a maximum packet length is exceeded, then the data areas are divided into a plurality of packets (second relay step).

Subsequently, in the case where a synchronization control packet is transmitted toward an adjacent equipment in synchronism with a synchronization timing signal, the packet multiplexing and broadcasting circuit 19 transmits the above-mentioned information packets in the wake of the synchronization control packet in such a state as to be synchronized with the next synchronization timing signal. In the case where a synchronization control packet is not transmitted, the packet multiplexing and broadcasting circuit 19 transmits the above-mentioned information packets in synchronism with a synchronization timing signal (third relay step).

Furthermore, the multiplexing equipment 13 conducts broadcast relay of information packets as well received from an 1 side route of a 1:N multiplexing and broadcasting communication system to an N side route of the 1:N multiplexing and broadcasting communication system in the same way as the foregoing description. However, the multiplexing equipment 13 does not compile the received information packets, but broadcasts the received information packets as they are to respective routes of the N side of the 1:N multiplexing and broadcasting communication system (fourth relay step).

Furthermore, the reception side terminal equipment 12 previously sets an attribute (such as an identifier of the transmission side terminal equipment 11) of each information of each transmission side terminal equipment 11 included in information packets, in the equipment. Furthermore, the reception side terminal equipment 12 conducts predetermined processing on information packets received from the multiplexing equipment 13 on the basis of the pertinent attribute (fifth relay step).

In the present embodiment, the packet communication system is designed so that the sum of the total transmission time of data areas except packet headers of information packets transmitted by all transmission terminal equipments 11 during a period T and transmission time of one packet of the synchronization control packet will not exceed the period T.

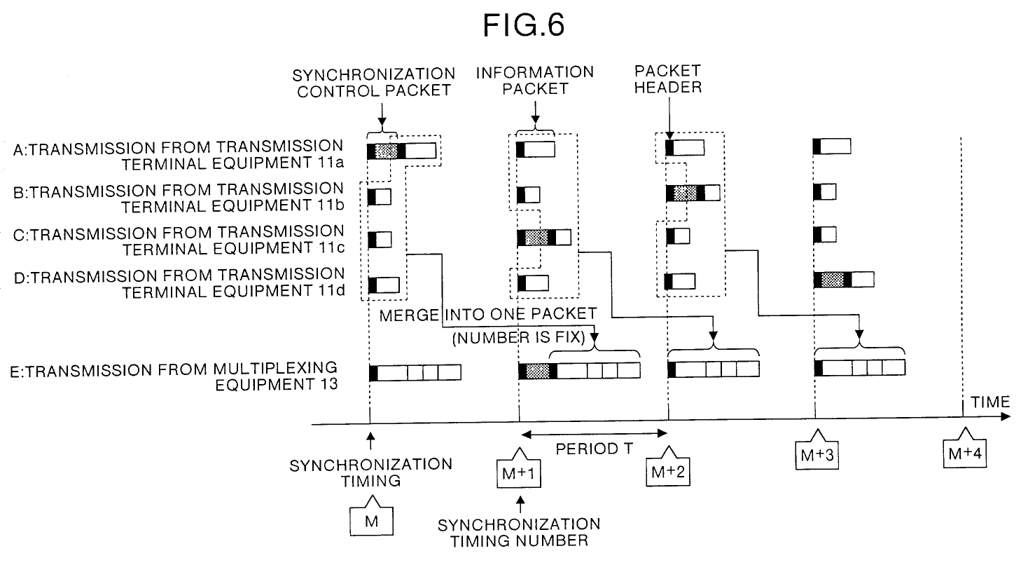

Operations (synchronizing methods) of the equipments in the second embodiment having the system configuration shown in FIG. 4 will now be described by referring to a timing chart of FIG. 6. As shown in FIG. 6, in the packet communication system of the present embodiment, the transmission operation of the synchronization control packet and the transmission operation of information packets do not compete with each other in the transmission side terminal equipments 11a, 11b, 11c and 11d and the multiplexing equipment 13. Each of the transmission side terminal equipments 11a, 11b, 11c and 11d and the multiplexing equipment 13 can transmit the synchronization control packet with a delay of a fixed delay time from its own synchronization timing. In addition, a data quantity equivalent to the number of bits of a packet header×the number of multiplexed packets is reduced.

According to the packet communication system of the second embodiment of the present invention, effects similar to those of the first embodiment are obtained as heretofore described. In addition, by multiplexing information of the transmission side terminal equipments 11 (11a, 11b, 11c and 11d) into one information packet, the amount of processing of the multiplexing equipment 13 increases, but the multiplexing efficiency can be improved. There is brought about an effect that it becomes possible to constitute a further larger scale packet communication system than that of the first embodiment.

Third Embodiment

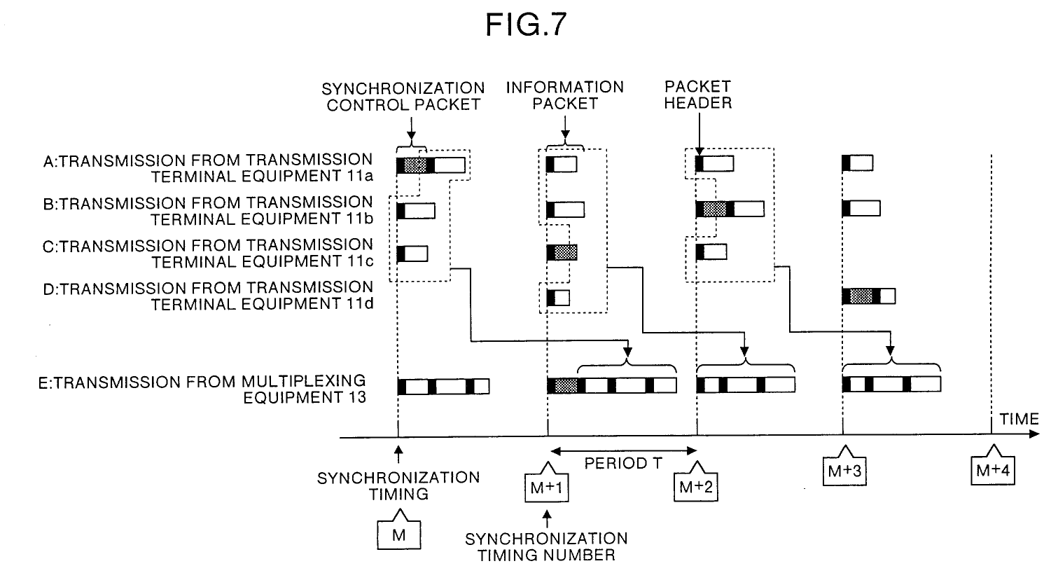

A third embodiment of the present invention will be described in detail by referring to the drawing. FIG. 7 is a timing chart showing operations of respective equipments in the third embodiment having the system configuration shown in FIG. 4.

An object of a packet communication system of the present embodiment is to improve the multiplexing efficiency in the case where transmission side terminal equipments having various transmission periods are accommodated. A configuration of the system is similar to that of the first embodiment shown in FIG. 1. Configurations of respective equipments, operation relating to timing synchronization, and information packet relay operation of the multiplexing equipment 13 are similar to those of the first embodiment. However, only the information packet transmission operation of the transmission side terminal equipments 11 (11a, 11b, 11c and 11d) differs from that of the first embodiment. Hereafter, therefore, only portions different from the first embodiment will be described. The same portions as those already described with reference to the first embodiment are denoted by like characters, and duplicated description will be omitted.

In the present embodiment, the transmission side terminal equipment 11 transmits information packets as heretofore described. By the way, an example of operation of two transmission side terminal equipments 11 that transmit analog signal information (digital signals) obtained by conducting A/D conversion at a period equivalent to twice the period T is shown in ensuing parentheses.

In the packet communication system of the present embodiment, first in the transmission side terminal equipment 11 shown in FIG. 3, the synchronization control circuit 20 transmits a synchronization control packet to an adjacent equipment in synchronism with a synchronization timing signal in accordance with the above-mentioned timing synchronization procedure, and thereby conducts timing synchronization (first transmission step).

Subsequently, the A/D conversion circuit 16 conducts A/D conversion on an analog signal input from the analog signal input terminal, in synchronism with a synchronization timing signal having a synchronization timing number (such as, for example, a number having a multiple of 2 at the end) predetermined for each of the transmission side terminal equipments 11 (second transmission step). Subsequently, the packet assembly circuit 17 stores information after the A/D conversion in the second transmission step, in data areas of information packets (third transmission step).

Subsequently, in the case where a synchronization control packet is transmitted toward an adjacent equipment in synchronism with a synchronization timing signal, in a period T of a synchronization timing number (for example, the above-mentioned number+1 for one of the two transmission side terminal equipments, and the above-mentioned number+2 for the other of the two transmission side terminal equipments) predetermined for each of transmission side terminal equipments 11 after the above-mentioned synchronization timing number, the packet assembly circuit 17 transmits the information packets stored in the third transmission step toward the opposite reception side terminal equipment 12 (12a, 12b) in the wake of the synchronization control packet. In the case where a synchronization control packet is not transmitted, the packet assembly circuit 17 transmits the information packets in synchronism with a synchronization timing signal (fourth transmission step).

In the packet communication system of the present embodiment, the packet communication system is designed so that the sum of the total transmission time of information packets transmitted by respective transmission side terminal equipments 11 during each period T and transmission time of one packet of the synchronization control packet will not exceed the period T.

When an information packet transmission period of an arbitrary transmission side terminal equipment 11 (11a, 11b, 11c, and 11d) is not an integer times the period T, but, for example, 1.5 T, it is necessary to transmit the information packets at a rate of two frames in 3 T (for example, in synchronism with a synchronization timing signal having a multiple of 3 at the end and a synchronization timing signal having a multiple of 3+1 at the end).

Operations (synchronizing methods) of the equipments in the third embodiment having the system configuration shown in FIG. 4 will now be described by referring to a timing chart of FIG. 7. Timing charts A, B, C, D and E in FIG. 7 correspond to transmission of directions of arrows A, B, C, D and E in FIG. 4, in the same way as FIG. 5.

With reference to FIG. 7, in the present embodiment, first each of the transmission side terminal equipments 11a and 11b transmits one of the information packets per period T. At this time, each of the transmission side terminal equipments 11c and 11d generates one information packet at a period equivalent to twice the period T. On this occasion, the transmission side terminal equipment 11c transmits information packets in periods T of synchronization timing numbers M, M+2, M+4, . . . . The transmission side terminal equipment 11d transmits information packets in periods T of synchronization timing numbers M+1, M+3, M+5 (not illustrated), . . . .

As shown in FIG. 7, in the packet communication system of the present embodiment, the transmission operation of the synchronization control packet and the transmission operation of information packets do not compete with each other in the transmission side terminal equipments 11a, 11b, 11c and 11d and the multiplexing equipment 13. Each of the transmission side terminal equipments 11a, 11b, 11c and 11d and the multiplexing equipment 13 can transmit the synchronization control packet with a delay of a fixed delay time from its own synchronization timing. Furthermore, information packets are not carried over to the next period T to be transmitted. Neither discard of an information from the packet reception buffer nor a delay exceeding the above-mentioned equation (2) occurs.

According to the packet communication system of the third embodiment of the present invention, effects similar to those of the first embodiment are obtained as heretofore described. In addition, the transmission side terminal equipments 11 (11a, 11b, 11c and 11d) having various transmission periods transmit information packets dispersedly. As compared with the case where the information packets are transmitted simultaneously, therefore, the multiplexing efficiency can be improved. There is brought about an effect that it becomes possible to constitute a further larger scale packet communication system than that of the first embodiment.

Fourth Embodiment

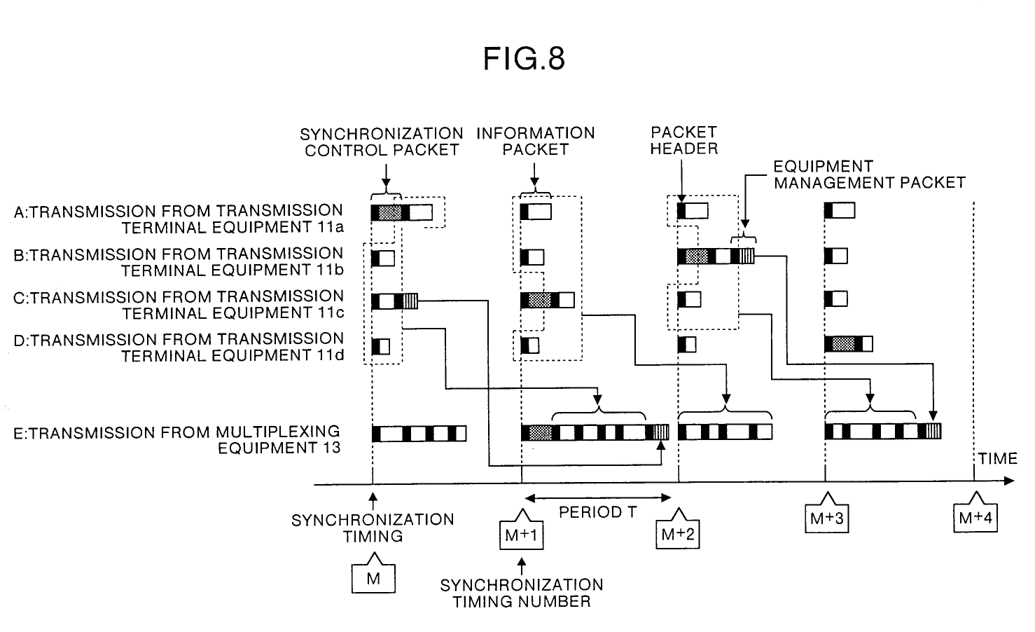

A fourth embodiment of the present invention will be described in detail by referring to the drawing. FIG. 8 is a timing chart showing operations (synchronizing methods) of respective equipments in the fourth embodiment having the system configuration shown in FIG. 4. An object of a packet communication system of the present embodiment is to make respective equipments transmit and receive an equipment management packet together with the synchronization control packet and the information packets.

A configuration of the system is similar to that of the first embodiment shown in FIG. 1. Configurations of respective equipments, operation concerning timing synchronization, and operation concerning the transmission and reception of information packets are similar to those of the first embodiment. However, operation concerning transmission and reception of the equipment management packet is added to the first embodiment. Hereafter, therefore, only portions different from the first embodiment will be described. The same portions as those already described with reference to the first embodiment are denoted by like characters, and duplicated description will be omitted. By the way, the equipment management packet is a packet to be used to notify and collect failure information of respective equipments and update initial setting parameters of respective equipments and operation programs.

When a synchronization control packet is transmitted toward an adjacent equipment in synchronism with a synchronization timing signal in accordance with the above-mentioned timing synchronization procedure, each equipment in the packet communication system of the present embodiment first transmits equipment management packets that do not exceed a packet length and a number predetermined for each equipment toward an opposite equipment in the wake of the synchronization control packet (first transmission step). At this time, in the case where information packets are also transmitted, it doesn't matter whether information packets are transmitted earlier than the equipment management packet or not.

On the other hand, in the case where a synchronization control packet is not transmitted, the above-mentioned equipment management packet is transmitted in synchronism with a synchronization timing signal (second transmission step). At this time, in the case where information packets are also transmitted, it doesn't matter whether information packets are transmitted earlier than the equipment management packet or not.

If the destination of the equipment management packet is an equipment beyond the multiplexing equipment 13, the multiplexing equipment 13 temporarily stores the equipment management packet and conducts relay in accordance with the above-mentioned first transmission step and second transmission step while conducting an adjustment so as not to exceed the above-mentioned packet length and number predetermined for the multiplexing equipment 13.

In the packet communication system of the present embodiment, the packet communication system is designed so that the sum of the total transmission time of information packets transmitted by all transmission side terminal equipments 11 (11a, 11b, 11c and 11d) during the period T, transmission time of one packet of the synchronization control packet, and transmission time of the equipment management packet under conditions predetermined for each equipment will not exceed the period T in each link.

Operations (synchronizing methods) of the equipments in the fourth embodiment having the system configuration shown in FIG. 4 will now be described by referring to a timing chart of FIG. 8. Timing charts A, B, C, D and E in FIG. 8 correspond to transmission of directions of arrows A, B, C, D and E in FIG. 4, in the same way as FIG. 5.

With reference to FIG. 8, in the packet communication system of the present embodiment, first each of the transmission side terminal equipments 11 (11a, 11b, 11c and 11d) transmits one of the information packets per period T. Furthermore, each of the transmission side terminal equipments 11b and 11c transmits one of the equipment management packets in each of periods T respectively having a synchronization timing number of M+2 and a synchronization timing number of M.

In the transmission side terminal equipments 11 (11a, 11b, 11c and 11d) and the multiplexing equipment 13, the transmission operation of the synchronization control packet, the transmission operation of information packets, and the transmission operation of equipment management packet do not compete with each other. Each of the transmission side terminal equipments 11 (11a, 11b, 11c and 11d) and the multiplexing equipment 13 can transmit the synchronization control packet with a delay of a fixed delay time from its own synchronization timing. Furthermore, information packets are not carried over to the next period T to be transmitted. Neither discard of an information from the packet reception buffer nor a delay exceeding the above-mentioned equation (2) occurs.

According to the packet communication system of the fourth embodiment of the present invention, effects similar to those of the first embodiment are obtained as heretofore described. In addition, each equipment can transmit and receive the equipment management packet together with the synchronization control packet and the information packets. There is brought about an effect that it becomes possible to constitute a further larger scale packet communication system than that of the first embodiment by using the equipment management packet.

Fifth Embodiment

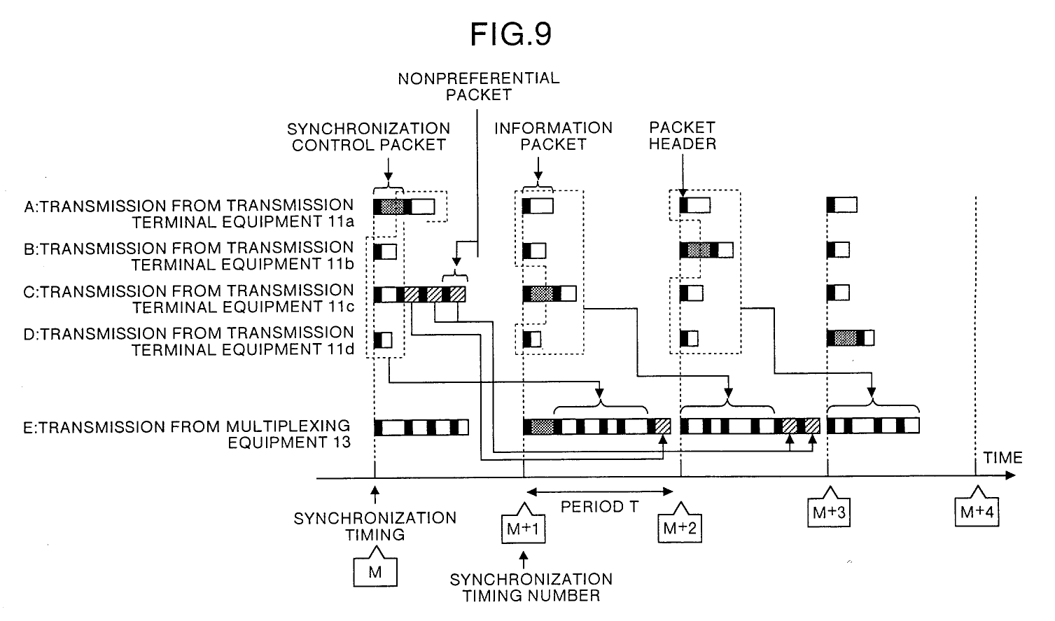

A fifth embodiment of the present invention will be described in detail by referring to the drawing. FIG. 9 is a timing chart showing operations (synchronizing methods) of respective equipments in the fifth embodiment having the system configuration shown in FIG. 4.

An object of a packet communication system according to the fifth embodiment of the present invention is to make respective equipments transmit and receive nonpreferential information packets together with the synchronization control packet and the information packets.

A configuration of the system is similar to that of the first embodiment shown in FIG. 1. Configurations of respective equipments, operation concerning timing synchronization, and operation concerning the transmission and reception of information packets are similar to those of the first embodiment. However, operation concerning transmission and reception of the nonpreferential information packets is added to the first embodiment. Hereafter, therefore, only portions different from the first embodiment will be described. The same portions as those already described with reference to the first embodiment are denoted by like characters, and duplicated description will be omitted. By the way, the nonpreferential information packet is a packet of best effort type that is retransmitted by a communication procedure of a higher order layer even if it is discarded because of system congestion.

In the packet communication system of the present embodiment, the transmission side terminal equipment 11 (11a, 11b, 11c and 11d) executes a first transmission step and a second transmission step described hereafter, if it has nonpreferential information packets to be transmitted.

That is, if there is left a time required to transmit a packet of a maximum length by the next synchronization timing signal after transmission of a synchronization control packet and information packets, then the transmission side terminal equipment 11 (11a, 11b, 11c and 11d) transmits nonpreferential information packets to an opposite terminal equipment (first transmission step).

Furthermore, if there is not left a time required to transmit a packet of a maximum length by the next synchronization timing signal even if nonpreferential information packets to be transmitted remain, then transmission is attempted again in the next period T (second transmission step).

On the other hand, the multiplexing equipment 13 relays nonpreferential information packets in first to third relay steps described hereafter. That is, the multiplexing equipment 13 temporarily holds the received nonpreferential information packets (first relay step).

If a time required to transmit a packet of a maximum length by the next synchronization timing signal is left in a period T after transmission of a synchronization control packet and relay of the information packets, then the multiplexing equipment 13 relays the above-mentioned nonpreferential information packets (second relay step). If there is not left a time required to transmit a packet of a maximum length by the next synchronization timing signal even if nonpreferential information packets to be relayed remain, then relay is attempted again in the next period T (third relay step).

Operations (synchronizing methods) of the equipments in the fifth embodiment having the system configuration shown in FIG. 4 will now be described by referring to a timing chart of FIG. 9. Timing charts A, B, C, D and E in FIG. 9 correspond to transmission of directions of arrows A, B, C, D and E in FIG. 4, in the same way as FIG. 5.

With reference to FIG. 9, in the packet communication system of the present embodiment, first each of the transmission side terminal equipments 11 (11a, 11b, 11c and 11d) transmits one of the information packets per period T, and transmits three nonpreferential packets in a period T having a synchronization timing number of M.

In the transmission side terminal equipments 11 and the multiplexing equipment 13, the transmission operation of the synchronization control packet, the transmission operation of information packets, and the transmission operation of nonpreferential information packets do not compete with each other as shown in FIG. 9. Each equipment can transmit the synchronization control packet with a delay of a fixed delay time from its own synchronization timing. Furthermore, information packets are not carried over to the next period T to be transmitted. Neither discard of an information from the packet reception buffer nor a delay exceeding the above-mentioned equation (2) occurs. By the way, if nonpreferential information packets exceeding the capacity of a packet reception buffer for nonpreferential information packet have been received, discarding is conducted.

According to the packet communication system of the fifth embodiment of the present invention, effects similar to those of the first embodiment are obtained as heretofore described. In addition, each equipment can transmit and receive nonpreferential information packets together with the synchronization control packet and the information packets. There is brought about an effect that it becomes possible to constitute a packet communication system having a higher degree of freedom than that of the first embodiment by using the nonpreferential information packets.

Sixth Embodiment

A sixth embodiment of the present invention will be described by referring to the drawing. An object of the packet communication system according to the sixth embodiment of the present invention is to improve the reliability so that a fault of a part of the system will not affect the whole system.

A configuration of the system is similar to that of the first embodiment shown in FIG. 1. Configurations of each equipments, operation concerning timing synchronization, and operation concerning the transmission and reception of information packets are similar to those of the first embodiment. However, operation conducted when a fault on the system has been detected is added to the first embodiment. Hereafter, therefore, only portions different from the first embodiment will be described. The same portions as those already described with reference to the first embodiment are denoted by like characters, and duplicated description will be omitted.

It is now assumed in the packet communication system of the present embodiment that the multiplexing equipment 13 has detected between itself and an adjacent equipment either an event indicating an error of the above-mentioned timing synchronization procedure (such as unaccomplished reception of a synchronization control packet) or an event indicating that the number of information packets received between immediately preceding synchronization timing and the next synchronization timing signal has exceeded a preset value. In this case, the multiplexing equipment 13 does not relay (inhibits) information packets received from the pertinent adjacent equipment until the pertinent event is canceled.

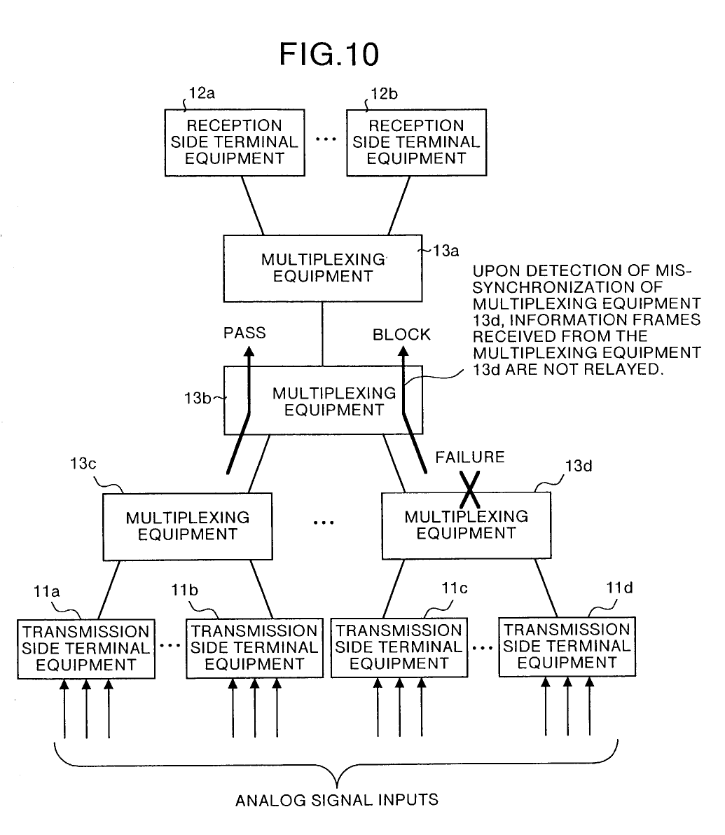

Operation (synchronizing method) of the multiplexing equipments 13a, 13b, 13c and 13d in the case where a failure of an adjacent equipment has been detected in the packet communication system of the fifth embodiment will now be described by referring to FIG. 10. Hereafter, an example of operation conducted in the case where the multiplexing equipment 13a, 13b, 13c or 13d has detected a failure of an adjacent equipment.

With reference to FIG. 10, if a multiplexing equipment 13d in the packet communication system of the present embodiment fails, then the multiplexing equipment 13b (relay equipment) detects an error of the above-mentioned timing synchronization procedure with respect to the multiplexing equipment 13d, and the multiplexing equipment 13b (relay equipment) does not relay information packets received from the multiplexing equipment 13d (a path denoted by illustrated “Block”), but relays information packets received from the multiplexing equipment 13c (a path denoted by illustrated “Pass”).

According to the packet communication system of the sixth embodiment of the present invention, effects similar to those of the first embodiment are obtained as heretofore described. In addition, information packets received from a fault equipment and disturbed in transmission period are not relayed, and consequently information packets received from other equipments can be relayed without obstructing them. Therefore, there is brought about an effect that it becomes possible to constitute a packet communication system having a higher degree of freedom than that of the first embodiment.

The above-mentioned embodiments 3 to 6 are based on the first embodiment. Even if they are based on the second embodiment, however, effects similar to those described above are obtained. Furthermore, in the above-mentioned first to sixth embodiments, multiplexing equipments have been used as the relay equipments. However, the present invention is not limited to the above-mentioned embodiments. Even if exchange equipments each having a N:N exchange function are used, operations and effects similar to those of the first to sixth embodiments are obtained.

Furthermore, in the first to sixth embodiments, the transmission side terminal equipments have been discriminated from the reception side terminal equipments. However, the present invention is not limited to the above-mentioned embodiments. Even if both the transmission side terminal equipments and the reception side terminal equipments transmit and receive information packets, operations and effects similar to those of the first to sixth embodiments are obtained.

Furthermore, in the first to sixth embodiments, the synchronization timing whereby the transmission side terminal equipment conducts A/D conversion on an analog signal is made the same as the synchronization timing whereby the transmission side terminal equipment transmits the synchronization control packet. However, the present invention is not limited to the above-mentioned embodiments. Even if there is a fixed time difference between them, operations and effects similar to those of the first to sixth embodiments are obtained.

Also, in the above-embodiment 1 to 6, such a configuration has been employed that the multiplexing equipment held the information packet only one period and relays the same. However the present invention is not limited to the above-embodiments, but the similar operation and effect to those of the first to sixth embodiments can be achieved even when such a configuration is employed that the information packet is held by integer times the period and is relayed.

Furthermore, the numbers, positions and shapes of the above-mentioned constituent members are not limited to those of the above-mentioned embodiments, but numbers, positions and shapes suitable for implementing the present invention may be adopted. In respective FigS, the same components are denoted by like characters.

As heretofore described, according to this invention, each of the terminal equipments and relay equipments transmits a synchronization request packet to an adjacent equipment at its own operation timing and thereby conducts a synchronization request. When a synchronization request packet is accepted from the adjacent equipment, each of the terminal equipments and relay equipments transmits a synchronization response packet corresponding to the synchronization request packet according to its own synchronization timing and thereby conducts a synchronization response, calculates a synchronization deviation value with respect to an adjacent equipment on the basis of a time difference between an arrival time of the synchronization response packet transmitted from the adjacent equipment and own operation timing, and corrects the operation timing of the own equipment on the basis of the calculated synchronization deviation value. Such a configuration brings about an effect that there can be obtained a packet communication system capable of executing timing synchronization among a plurality of terminal equipments, reducing the capacity of the packet reception buffer, and definitely assuring the maximum value of the transmission delay time of the information packets.

According to the next invention, each of the terminal equipments transmits information packets having a number and a length predetermined for each terminal equipment toward an opposite terminal equipment in the wake of the synchronization request, and each of the relay equipments temporarily stores information packets received between the current operation timing and the next operation timing, and relays information packets temporarily stored in the storage unit in the wake of the synchronization request packet at next operation timing. Such a configuration brings about an effect that there can obtained a packet communication system capable of conducting packet communication efficiently.

According to the next invention, each of the relay equipments extracts only data portions of information packets received between current operation timing and next operation timing, when relaying information packets from an N side route of a 1:N multiplexing and broadcasting communication system to a 1 side route, generates packets having data portions extracted by the extraction unit and arranged in a predetermined order, and relays the packets in the wake of the synchronization request packet at next operation timing. Such a configuration brings about an effect that there can obtained a packet communication system having an increased multiplexing efficiency although the amount of processing of the relay equipment is increased and consequently capable of coping with a large scale system.

According to the next invention, terminal equipments and relay equipments share a synchronization timing number that increases by 1 every operation timing according to timing synchronization control, and each of the relay equipments transmits packets having a number and a length predetermined for each terminal equipment toward an opposite terminal equipment in the wake of the synchronization request at operation timing specified by a synchronization timing number predetermined for each terminal equipment. Such a configuration brings about an effect that there can obtained a packet communication system having an increased multiplexing efficiency by transmitting information packets dispersedly as compared with the case where the information packets are transmitted simultaneously, and consequently capable of coping with a large scale system.

According to the next invention, each of the terminal equipments and relay equipments transmits an equipment management packet for notification and collection of failure information and update of initial setting parameters and operation programs of respective equipments, toward an adjacent equipment in the wake of the synchronization request packet according to a length and a number predetermined for each of the terminal equipments and relay equipment. Such a configuration brings about an effect that there can obtained such a packet communication system that each equipment can transmit and receive the equipment management packet together with the synchronization control packet and the information packets and a highly reliable system can be constituted.

According to the next invention, each of the terminal equipments has packets of best effort type that are retransmitted by a communication procedure of a higher order layer even if the packets have been discarded because of system congestion, as nonpreferential information packets. When there is a time for transmitting information packets of a maximum length in an interval between transmission of an information packet and next operation timing, each of the terminal equipments transmits the nonpreferential information packets toward opposite terminal equipment. When there is a time required for transmission of information packets of a maximum length in an interval between relay and next operation timing, each of the relay equipments relays the nonpreferential information packets. Such a configuration brings about an effect that there can obtained such a packet communication system that each equipment can transmit and receive the equipment management packet together with the synchronization control packet and the information packets and packet communication having a higher degree of freedom can be conducted by using the nonpreferential information packets.

According to the next invention, each of the relay equipments detects an error of a timing synchronization procedure or an excess of the number of information packets between the relay equipment and an adjacent equipment. When an error of a timing synchronization procedure or an excess of the number of information packets has been detected, the relay equipment stops the relay of information packets until the error of a timing synchronization procedure or excess of the number of information packets is canceled. Such a configuration brings about an effect that there can obtained such a packet communication system that information packets received from a fault equipment and disturbed in transmission period are not relayed, and consequently information packets received from other equipments can be relayed without obstructing them.

According to the next invention, each of the terminal equipments and relay equipments transmits a synchronization request packet to an adjacent equipment at its own operation timing and thereby conducts a synchronization request. When a synchronization request packet is accepted from the adjacent equipment, each of the terminal equipments and relay equipments transmits a synchronization response packet corresponding to the synchronization request packet according to its own synchronization timing and thereby conducts a synchronization response, calculates a synchronization deviation value with respect to an adjacent equipment on the basis of a time difference between an arrival time of the synchronization response packet transmitted from the adjacent equipment and own operation timing, and corrects the operation timing of the own equipment on the basis of the calculated synchronization deviation value. Such a configuration brings about an effect that there can be obtained a packet communication method capable of executing timing synchronization among a plurality of terminal equipments, reducing the capacity of the packet reception buffer, and definitely assuring the maximum value of the transmission delay time of the information packets.

According to the next invention, each of the terminal equipments transmits information packets having a number and a length predetermined for each terminal equipment toward an opposite terminal equipment in the wake of the synchronization request, and each of the relay equipments temporarily stores information packets received between the current operation timing and the next operation timing, and relays information packets temporarily stored in the storage unit in the wake of the synchronization request packet at next operation timing. Such a configuration brings about an effect that there can obtained a packet communication method capable of conducting packet communication efficiently.

According to the next invention, each of the relay equipments extracts only data portions of information packets received between current operation timing and next operation timing, when relaying information packets from an N side route of a 1:N multiplexing and broadcasting communication system to a 1 side route, generates packets having data portions extracted by the extraction unit and arranged in a predetermined order, and relays the packets in the wake of the synchronization request packet at next operation timing. Such a configuration brings about an effect that there can obtained a packet communication method having an increased multiplexing efficiency although the amount of processing of the relay equipment is increased and consequently capable of coping with a large scale system.

According to the next invention, terminal equipments and relay equipments share a synchronization timing number that increases by 1 every operation timing according to timing synchronization control, and each of the relay equipments transmits packets having a number and a length predetermined for each terminal equipment toward an opposite terminal equipment in the wake of the synchronization request at operation timing specified by a synchronization timing number predetermined for each terminal equipment. Such a configuration brings about an effect that there can obtained a packet communication method having an increased multiplexing efficiency by transmitting information packets dispersedly as compared with the case where the information packets are transmitted simultaneously, and consequently capable of coping with a large scale system.

According to the next invention, each of the terminal equipments and relay equipments transmits an equipment management packet for notification and collection of failure information and update of initial setting parameters and operation programs of respective equipments, toward an adjacent equipment in the wake of the synchronization request packet according to a length and a number predetermined for each of the terminal equipments and relay equipment. Such a configuration brings about an effect that there can obtained such a packet communication method that each equipment can transmit and receive the equipment management packet together with the synchronization control packet and the information packets and a highly reliable system can be constituted.

According to the next invention, each of the terminal equipments has packets of best effort type that are retransmitted by a communication procedure of a higher order layer even if the packets have been discarded because of system congestion, as nonpreferential information packets. When there is a time for transmitting information packets of a maximum length in an interval between transmission of an information packet and next operation timing, each of the terminal equipments transmits the nonpreferential information packets toward opposite terminal equipment. When there is a time required for transmission of information packets of a maximum length in an interval between relay and next operation timing, each of the relay equipments relays the nonpreferential information packets. Such a configuration brings about an effect that there can obtained such a packet communication method that each equipment can transmit and receive the equipment management packet together with the synchronization control packet and the information packets and packet communication having a higher degree of freedom can be conducted by using the nonpreferential information packets.

According to the next invention, each of the relay equipments detects an error of a timing synchronization procedure or an excess of the number of information packets between there lay equipment and an adjacent equipment. When an error of a timing synchronization procedure or an excess of the number of information packets has been detected, the relay equipment stops the relay of information packets until the error of a timing synchronization procedure or excess of the number of information packets is canceled. Such a configuration brings about an effect that there can obtained such a packet communication method that information packets received from a fault equipment and disturbed in transmission period are not relayed, and consequently information packets received from other equipments can be relayed without obstructing them.

According to the next invention, a computer program for making a computer execute a method described in any one of the above-mentioned methods is recorded. Accordingly, it becomes possible to read the computer program by using a machine. This brings about an effect that there is obtained such a recording medium that operation of any of the above-mentioned methods can be implemented by using a computer.

### INDUSTRIAL APPLICABILITY

As heretofore described, a packet communication system, a packet communication method, and a computer readable recording medium having a computer program for making a computer execute the method recorded thereon according to the present invention are suitable for a packet communication system comprised of a plurality of terminal equipments that operate according to mutually synchronized periodic timing signals and at least one relay equipment, and for its synchronizing technique. In particular, they are suitable for a packet communication system capable of improving the band utilization factor of the transmission path and definitely assuring a maximum value of a transmission delay time required since the terminal equipment transmits information packets until they arrive at the opposite terminal equipment.

1. A packet communication system comprising:
a plurality of terminal equipments that conduct communication operation at periodic timing; and
relay equipments that relay packets transmitted between said terminal equipments, wherein synchronization control packets for timing synchronization are transmitted between adjacent equipments to thereby establish synchronization of operation timing,
each of said terminal equipments and relay equipments including,
a synchronization request unit which transmits a synchronization request packet to an adjacent equipment at own operation timing and thereby performs a synchronization request;
a synchronization response unit which is responsive to acceptance of a synchronization request packet from said adjacent equipment, for transmitting a synchronization response packet corresponding to the synchronization request packet according to own synchronization timing and thereby conducting a synchronization response;
a calculation unit which calculates a synchronization deviation value with respect to an adjacent equipment on the basis of a time difference between an arrival time of the synchronization response packet transmitted from said adjacent equipment and own operation timing; and
a correction unit which corrects operation timing of the own equipment on the basis of the synchronization deviation value calculated by said calculation unit.

2. The packet communication system according to claim 1, wherein each of said terminal equipments comprises an information packet transmission unit which transmits information packets having a number and a length predetermined for each terminal equipment toward an opposite terminal equipment in the wake of the synchronization request or response, and each of said relay equipments comprises a storage unit which temporarily stores information packets received between the current operation timing and next operation timing; and a relay unit which relays information packets stored in said storage unit in the wake of the synchronization request or response packet at next operation timing.

3. The packet communication system according to claim 2, wherein each of said relay equipments further comprises
an extraction unit which extracts only data portions of information packets received between current operation timing and next operation timing, when relaying information packets from an N side route of a 1:N multiplexing and broadcasting communication system to a 1 side route; and a packet generation unit which generates packets having data portions extracted by said extraction unit and arranged in a predetermined order, and
said relay unit relays packets generated by said packet generation unit in the wake of the synchronization request or response packet at next operation timing.

4. The packet communication system according to claim 1, wherein said terminal equipments and relay equipments have a same synchronization timing number that increases by 1 every operation timing according to timing synchronization control, and each of said terminal equipments transmits packets having a number and a length predetermined for each terminal equipment toward an opposite terminal equipment in the wake of the synchronization request or response at operation timing specified by a synchronization timing number predetermined for each terminal equipment.

5. The packet communication system according to claim 1, wherein each of said terminal equipments and relay equipments transmits an equipment management packet for notification and collection of failure information and update of initial setting parameters and operation programs of respective equipments, toward an adjacent equipment in the wake of the synchronization request or response packet according to a length and a number predetermined for each of said terminal equipments and relay equipment.

6. The packet communication system according to claim 1, wherein each of said terminal equipments has packets of best effort type that are retransmitted by a communication procedure of a higher order layer even if said packets have been discarded because of system congestion, as nonpreferential information packets; when there is a time for transmitting information packets of a maximum length in an interval between transmission of an information packet and next operation timing, each of said terminal equipments transmits said nonpreferential information packets; and when there is a time required for transmission of information packets of a maximum length in an interval between relay and next operation timing, each of said relay equipments relays said nonpreferential information packets.

7. The packet communication system according to claim 1, wherein each of said relay equipments further comprises a detection unit which detects an error of a timing synchronization procedure or an excess of the number of information packets between said relay equipment and an adjacent equipment; and a relay stoping unit which is responsive to detection of an error of a timing synchronization procedure or an excess of the number of information packets conducted by said detection unit, for stopping the relay of information packets until said error of a timing synchronization procedure or excess of the number of information packets is canceled.

8. A packet communication method applicable to a packet communication system, said packet communication system including a plurality of terminal equipments that conduct communication operation at periodic timing; and relay equipments that relay packets transmitted between said terminal equipments, wherein synchronization control packets for timing synchronization are transmitted between adjacent equipments to thereby establish synchronization of operation timing, the packet communication method comprising:
a synchronization request step at which each of said terminal equipments and relay equipments transmits a synchronization request packet to an adjacent equipment at own operation timing and thereby conducting a synchronization request;
a synchronization response step at which, in response to acceptance of a synchronization request packet from said adjacent equipment, each of said terminal equipments and relay equipments transmits a synchronization response packet corresponding to the synchronization request packet according to own synchronization timing and thereby conducts a synchronization response;
a calculation step at which each of said terminal equipments and relay equipments calculates a synchronization deviation value with respect to an adjacent equipment on the basis of a time difference between an arrival time of the synchronization response packet transmitted from said adjacent equipment and own operation timing; and
a correction step at which each of said terminal equipments and relay equipments corrects operation timing of the own equipment on the basis of the synchronization deviation value calculated at the calculation step.

9. The packet communication method according to claim 8, further comprising:
an information packet transmission step at which each of said terminal equipments transmits information packets having a number and a length predetermined for each terminal equipment toward an opposite terminal equipment in the wake of the synchronization request or response; and
a relay step at which each of said relay equipments temporarily stores information packets received between the current operation timing and next operation timing, and relays information packets temporarily stored in said storage unit in the wake of the synchronization request or response packet at next operation timing.

10. The packet communication method according to claim 9, further comprising an extraction step at which each of said relay equipments extracts only data portions of information packets received between current operation timing and next operation timing, when relaying information packets from an N side route of a 1:N multiplexing and broadcasting communication system to a 1 side route; and a packet generation step at which each of said relay equipments generate packets having data portions extracted at said extraction step and arranged in a predetermined order, and
at the relay step, packets generated at the packet generation step are relayed in the wake of the synchronization request or response packet at next operation timing.

11. The packet communication method according to claim 8, wherein said terminal equipments and relay equipments have a same synchronization timing number that increases by 1 every operation timing according to timing synchronization control, and each of said terminal equipments transmits packets having a number and a length predetermined for each terminal equipment toward an opposite terminal equipment in the wake of the synchronization request or response at operation timing specified by a synchronization, timing number predetermined for each terminal equipment.

12. The packet communication method according to claim 8, wherein each of said terminal equipments and relay equipments transmits an equipment management packet for notification and collection of failure information and update of initial setting parameters and operation programs of respective equipments, toward an adjacent equipment in the wake of the synchronization request or response packet according to a length and a number predetermined for each of said terminal equipments and relay equipment.

13. The packet communication method according to claim 8, wherein each of said terminal equipments has packets of best effort type that are retransmitted by a communication procedure of a higher order layer even if said packets have been discarded because of system congestion, as nonpreferential information packets; when there is a time for transmitting information packets of a maximum length in an interval between transmission of an information packet and next operation timing, each of said terminal equipments transmits said nonpreferential information packets toward opposite terminal equipment; and when there is a time required for transmission of information packets of a maximum length in an interval between relay and next operation timing, each of said relay equipments relays said nonpreferential information packets.

14. The packet communication method according to claim 8, further comprising:
a detection step at which each of said relay equipments detects an error of a timing synchronization procedure or an excess of the number of information packets between said relay equipment and an adjacent equipment; and
a relay stop step at which, in response to detection of an error of a timing synchronization procedure or an excess of the number of information packets at said detection step, each of said relay equipments stops the relay of information packets until said error of a timing synchronization procedure or excess of the number of information packets is canceled.

15. A computer readable recording medium wherein a packet communication method of a packet communication system is recorded thereon as a computer program for making a computer execute a packet communication method applicable to a packet communication system, said packet communication system including a plurality of terminal equipments that conduct communication operation at periodic timing; and relay equipments that relay packets transmitted between said terminal equipments, wherein synchronization control packets for timing synchronization are transmitted between adjacent equipments to thereby establish synchronization of operation timing, the packet communication method comprising:
a synchronization request step at which each of said terminal equipments and relay equipments transmits a synchronization request packet to an adjacent equipment at own operation timing and thereby conducting a synchronization request;
a synchronization response step at which, in response to acceptance of a synchronization request packet from said adjacent equipment, each of said terminal equipments and relay equipments transmits a synchronization response packet corresponding to the synchronization request packet according to own synchronization timing and thereby conducts a synchronization response;
a calculation step at which each of said terminal equipments and relay equipments calculates a synchronization deviation value with respect to an adjacent equipment on the basis of a time difference between an arrival time of the synchronization response packet transmitted from said adjacent equipment and own operation timing; and
a correction step at which each of said terminal equipments and relay equipments corrects operation timing of the own equipment on the basis of the synchronization deviation value calculated at the calculation step.

16. A computer readable recording medium wherein a packet communication method of a packet communication system is recorded thereon as a computer program for making a computer execute a packet communication method applicable to a packet communication system, said packet communication system including a plurality of terminal equipments that conduct communication operation at periodic timing; and relay equipments that relay packets given and received between said terminal equipments, wherein synchronization control packets for timing synchronization are transmitted between adjacent equipments to thereby establish synchronization of operation timing, the packet communication method comprising:
a synchronization request step at which each of said terminal equipments and relay equipments transmits a synchronization request packet to an adjacent equipment at own operation timing and thereby conducting a synchronization request;
a synchronization response step at which, in response to acceptance of a synchronization request packet from said adjacent equipment, each of said terminal equipments and relay equipments transmits a synchronization response packet corresponding to the synchronization request packet according to own synchronization timing and thereby conducts a synchronization response;
a calculation step at which each of said terminal equipments and relay equipments calculates a synchronization deviation value with respect to an adjacent equipment on the basis of a time difference between an arrival time of the synchronization response packet transmitted from said adjacent equipment and own operation timing; and
a correction step at which each of said terminal equipments and relay equipments corrects operation timing of the own equipment on the basis of the synchronization deviation value calculated at the calculation step;
an information packet transmission step at which each of said terminal equipments transmits information packets having a number and a length predetermined for each terminal equipment toward an opposite terminal equipment in the wake of the synchronization request packet; and
a relay step at which each of said relay equipments temporarily stores information packets received between the current operation timing and next operation timing, and relays the temporarily stored information packets in the wake of the synchronization request packet at next operation timing.

17. A computer readable recording medium wherein a packet communication method of a packet communication system is recorded thereon as a computer program for making a computer execute a packet communication method applicable to a packet communication system, said packet communication system including a plurality of terminal equipments that conduct communication operation at periodic timing; and relay equipments that relay packets given and received between said terminal equipments, wherein synchronization control packets for timing synchronization are transmitted between adjacent equipments to thereby establish synchronization of operation timing, the packet communication method comprising:
a synchronization request step at which each of said terminal equipments and relay equipments transmits a synchronization request packet to an adjacent equipment at own operation timing and thereby conducting a synchronization request;
a synchronization response step at which, in response to acceptance of a synchronization request packet from said adjacent equipment, each of said terminal equipments and relay equipments transmits a synchronization response packet corresponding to the synchronization request packet according to own synchronization timing and thereby conducts a synchronization response;
a calculation step at which each of said terminal equipments and relay equipments calculates a synchronization deviation value with respect to an adjacent equipment on the basis of a time difference between an arrival time of the synchronization response packet transmitted from said adjacent equipment and own operation timing; and
a correction step at which each of said terminal equipments and relay equipments corrects operation timing of the own equipment on the basis of the synchronization deviation value calculated at the calculation step;
an information packet transmission step at which each of said terminal equipments transmits information packets having a number and a length predetermined for each terminal equipment toward an opposite terminal equipment in the wake of the synchronization request packet; and
a relay step at which each of said relay equipments temporarily stores information packets received between the current operation timing and next operation timing, and relays the temporarily stored information packets in the wake of the synchronization request packet at next operation timing;
an extraction step at which each of said relay equipments extracts only data portions of information packets received between current operation timing and next operation timing, when relaying information packets from an N side route of a 1:N multiplexing and broadcasting communication system to a 1 side route; and
a packet generation step at which each of said relay equipments generate packets having data portions extracted at said extraction step and arranged in a predetermined order,
wherein, at the relay step, packets generated at the packet generation step being relayed in the wake of the synchronization request packet at next operation timing.
